(19) United States
(12) Patent Application Publication
(10) Pub. No.: US 2005/0033726 A1
(43) Pub. Date: Feb. 10, 2005

(54) Apparatus and method for accessing diverse native data sources through a metadata interface

(76) Inventors: Ju Wu, Coquitlam (CA); Roger Sanborn, Maple Ridge (CA); Sandra Lutz, Vancouver (CA); Yuru Wang, Coquitlam (CA); Peter Jarvis, Woodbridge (GB); Justin Philip Smith, Ipswich (GB)

Correspondence Address: COOLEY GODWARD, LLP, 3000 EL CAMINO REAL, 5 PALO ALTO SQUARE, PALO ALTO, CA, 94306, US

(21) Appl. No.: 10/850,355

(22) Filed: May 19, 2004

Related U.S. Application Data
(60) Provisional application No. 60/472,068, filed on May 19, 2003.

(51) Int. Cl. G06F 7/00

(52) U.S. Cl. 707/1

(57) ABSTRACT

A computer readable medium storing executable instructions includes a metadata view module. The metadata view module has a data foundation module to facilitate data abstraction of enterprise data, where the enterprise data is stored in diverse native formats. A business element module facilitates the logical grouping of the enterprise data to form business elements and a business view module facilitates the logical grouping of business elements.

### CROSS REFERENCE TO RELATED APPLICATIONS

This application claims the benefit of U.S. Provisional Application Ser. No. 60/472,068, entitled “Apparatus And Method For Accessing Diverse Native Data Sources Through A Metadata Interface,” filed May 19, 2003, the contents of which are hereby incorporated by reference in their entirety.

### BRIEF DESCRIPTION OF THE INVENTION

This invention relates generally to data storage and retrieval. More particularly, this invention relates to accessing data in business environments to supply business intelligence solutions.

### BACKGROUND OF THE INVENTION

Business intelligence generally refers to software tools used to improve business enterprise decision-making. These tools are commonly applied to financial, human resource, marketing, sales, customer and supplier analyses. More specifically, these tools can include: reporting and analysis tools to present information; content delivery infrastructure systems for delivery and management of reports and analytics; data warehousing systems for cleansing and consolidating information from disparate sources; and, data management systems, such as relational databases or On Line Analytic Processing (OLAP) systems used to collect, store, and manage raw data.

These solutions form levels in a hierarchy or solution stack, each layer of which has a role in enabling the business user to gain access to the information required to understand how some aspect of a business is running and to support decisions that need to be made to resolve business issues. There is quite a range in the characteristics of the raw data that forms the basis of this information, such as how it is collected, or its timeliness. There is also a range in the characteristics of decisions that need to be made based upon the data, from daily tactical decisions, to more strategic long term decisions. In considering the broadness of the range in these characteristics, the specific capabilities provided by each level of the business intelligence stack vary tremendously.

Business intelligence tools are increasingly being challenged by the large amount of data that they are expected to process. Data explosion and exploration issues are inherent to many of today's corporate enterprises, particularly those that employ multiple, disparate data sources across the organization. Many of these companies now recognize the value of a metadata. Metadata is information about information. The information typically specifies how data is collected and formatted. Metadata facilitates understanding how information is stored in data warehouses. Metadata also facilitates greater consistency and manageability across data infrastructures.

Metadata is used to abstract the complexities of corporate data away from users so that it is easier for the users to build queries without using arcane computer syntax, such as Structured Query Language (SQL). Traditional implementations typically accomplish this by providing users with a selection of business terms from which they can formulate a user query that the system automatically converts to SQL.

A number of business intelligence vendors have delivered metadata functionality as a data integration tool that can be used to aggregate and store data for analytic use. However, existing implementations have rigid architectures with data models that cannot be reused. In addition, existing solutions rely upon transforming native data into a proprietary format for further processing. Consequently, existing architectures result in a proliferation of data. These prior art approaches impose significant change management issues and restrict the enterprise's flexibility to adjust to evolving organizational requirements.

In view of the foregoing, it would be highly desirable to provide a technique for accessing diverse native data sources through a metadata interface.

### SUMMARY OF THE INVENTION

The invention includes a computer readable medium storing executable instructions defining a metadata view module. The metadata view module has a data foundation module to facilitate data abstraction of enterprise data, where the enterprise data is stored in diverse native formats. A business element module facilitates the logical grouping of the enterprise data to form business elements and a business view module facilitates the logical grouping of business elements.

The invention also includes a method of accessing data. Enterprise data stored in diverse native formats is accessed. Sub-sets of enterprise data are logically grouped to form business elements. Sub-sets of business elements are then logically combined into a business view.

The invention allows organizations to consolidate data by dynamically mapping back-end data into business views that provide structured summaries of an organization's data assets. Advantageously, this is accomplished without copying the existing data into a new proprietary format. In other words, the invention allows metadata access to diverse native data sources. Business views provided in accordance with the invention can be secured at a granular level by administrators and be used as the basis for reporting, analysis and information delivery processes.

The invention makes it possible for organizations to reduce costs, improve profitability and increase customer focus by enabling users to use abstraction to transform the view of any disparate data and/or content across an enterprise into a more strategic, reusable information asset. That is, the invention helps organizations consolidate views of data by providing users with a common representation of data derived from either relational, OLAP, or other non-traditional structured data sources. From this common layer, users are able to independently perform automatic and transparent view transformations from heterogeneous data sources along dimensions with different hierarchy definitions without the need for administrative intervention. The invention allows one to merge business data from disparate sources into one semantic/meta layer that supports straightforward end user access via reports. This heterogeneous layer inherently copes with different data shapes and can be fashioned without an extract, transform and load operation, thus negating the necessity of having to replicate source data or involve an administrator to create a new view.

### BRIEF DESCRIPTION OF THE FIGURES

The invention is more fully appreciated in connection with the following detailed description taken in conjunction with the accompanying drawings, in which:

FIG. 1 illustrates interactions with a metadata view module in accordance with an embodiment of the invention.

FIG. 2 illustrates the metadata view module of the invention operative in connection with a relational database service and an OLAP data service.

FIG. 3 illustrates a computer configured in accordance with an embodiment of the invention.

FIG. 4 illustrates a graphical user interface that may be used to access software modules implemented in accordance with an embodiment of the invention.

FIGS. 5-8 illustrate interfaces that may be used to implement various connectivity functions of the invention.

FIG. 9 illustrates the abstraction of business views in accordance with an embodiment of the invention.

FIG. 10 illustrates an alternate embodiment of a metadata view module that may be utilized in accordance with an embodiment of the invention.

FIG. 11 illustrates the construction of business views in accordance with an embodiment of the invention.

FIG. 12 illustrates the construction of business views from disparate data sources in accordance with an embodiment of the invention.

FIG. 13 illustrates an architecture to support the processing of new data sources in accordance with an embodiment of the invention.

FIG. 14 illustrates a metadata view module of the invention operative with ancillary enterprise software modules.

FIG. 15 illustrates an example of how filters of the invention can be utilized to implement security operations.

Like reference numerals refer to corresponding parts throughout the several views of the drawings.

### DETAILED DESCRIPTION OF THE INVENTION

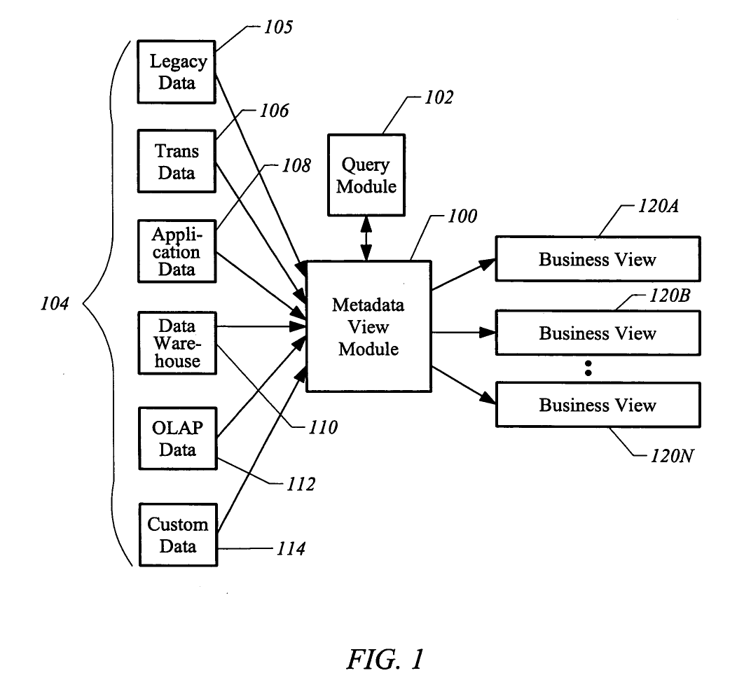

FIG. 1 illustrates a metadata view module 100 configured in accordance with an embodiment of the invention. The metadata view module 100 interfaces with a query module 102 to provide access to enterprise data in the form of an information store 104. In this example, the information store includes legacy data 105, transactional data (e.g., Customer Relation Management (CRM) data) 106, enterprise application data 108, warehouse data 110, On Line Analytic Processing (OLAP) data 112, and custom data 114. In one embodiment of the invention, the custom data 114 is application data that is accessed through developer interfaces, such as ADOTM record set from Microsoft Corporation, Redmond, Washington, and JROW™ set from Sun Microsystems, Menlo Park, Calif. The metadata view module 100 provides access to the diverse native data formats of the information store 104. This is accomplished without converting the diverse native data formats to a proprietary format. By accessing the data in this way, the metadata view module 100 provides various business views 102A-120N of the data in the information store 104.

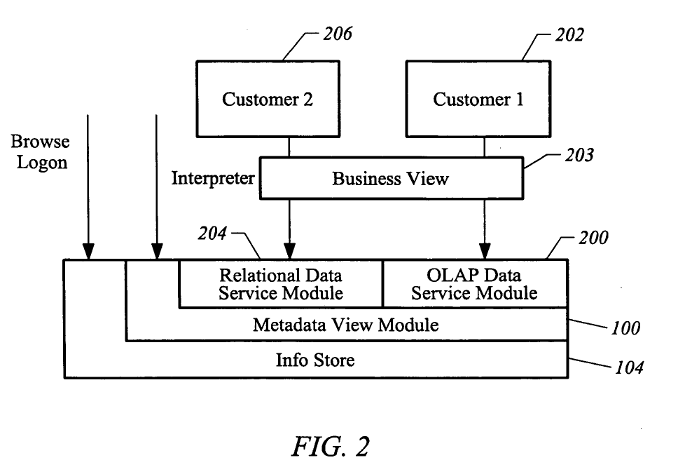

FIG. 2 illustrates an embodiment of the metadata view module 100 of the invention operative in connection with a relational database and an OLAP database. The information store 104 includes relational database information and OLAP database information. An OLAP data service module 200 interacts with a first consumer 202 through a business view 203. The metadata view module provides the OLAP data service module with a view into the information store 104. A relational data service module 204 interacts with a second consumer 206 through the same business view 203. The metadata view module provides the relational data service module 204 with a view into the information store 104. An interpreter may directly access the metadata view module 100. Logon and browse operations may be directly performed at the information store 104.

In sum, FIG. 2 illustrates that a single metadata view module 100 of the invention supports views into a disparate data sources, such as relational database and OLAP data sources. Although the term business view is used, the primary concept is that of a view in the form of a structured summary of data from disparate data sources. The data will typically relate to business data, but the term business contemplates information associated with any enterprise

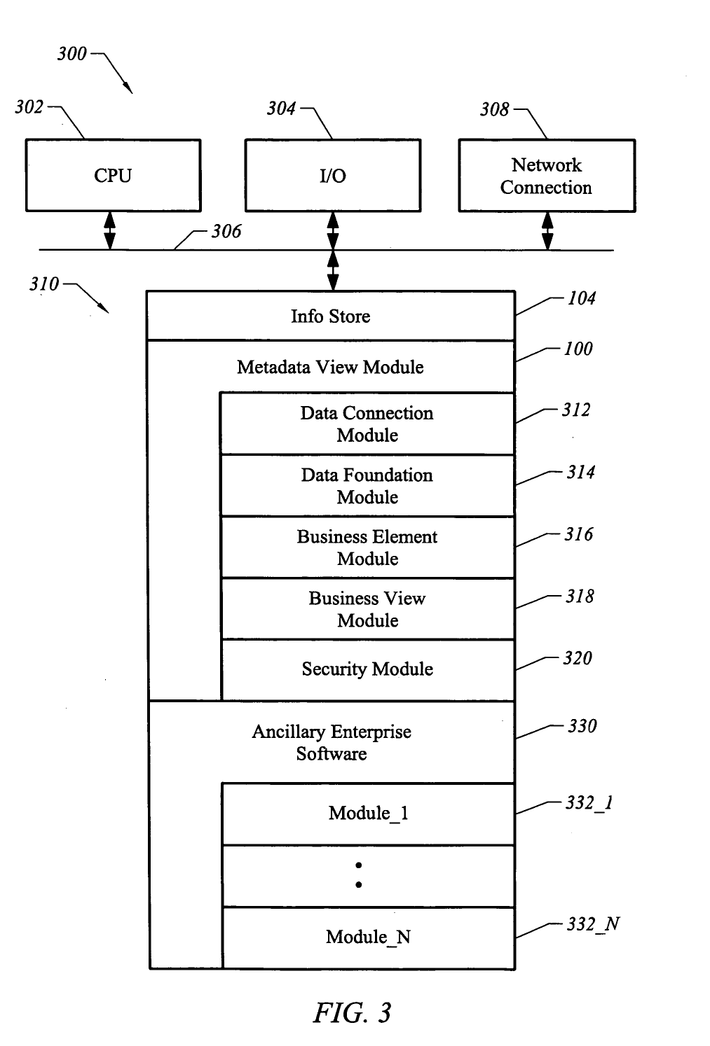

FIG. 3 illustrates a computer 300 configured in accordance with an embodiment of the invention. The computer 300 includes a central processing unit 302, which communicates with a set of input/output devices 304 over a bus 306. By way of example, the input/output devices may include a keyboard, mouse, trackball, monitor, printer, and the like. A network connection circuit 308 is also linked to the bus 306. The network connection circuit 308 provides access to other computers through intranets, the Internet, and the like.

A memory 310 is also connected to the bus 306. The memory 310 stores data and executable programs. The data stored in memory 310 includes enterprise data in the form of an information store 104. As shown in FIG. 1, the information store includes diverse native data formats, such as data formats 105-114. The memory 310 also stores a metadata view module 100, which includes executable instructions to implement the operations described herein. In one embodiment, the metadata view module 100 includes a data connection module 312, a data foundation module 314, a business element module 316, a business view module 318, and a security module 320. For the purpose of illustration, the metadata view module 100 of the invention is shown as residing on a single computer 300. However, it should be appreciated that the metadata view module 100 may be implemented in a distributed fashion across a network. In addition, the information store 104 can be and typically is implemented across a network.

The memory 310 also includes ancillary enterprise software 330. This software may include any number of modules 322_1 through 322_N to interact with and otherwise support the operation of the metadata view module 100. Examples of ancillary enterprise software modules that may be utilized in accordance with the invention are discussed below.

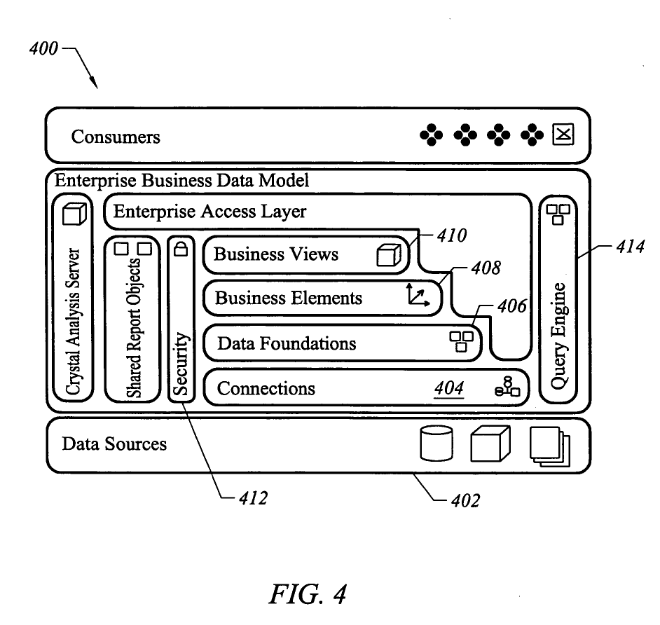

FIG. 4 illustrates a graphical user interface 400 that may be used to access the metadata view module 100. The interface 400 includes a data source interface 402, which provides access to the information store 104. The interface 400 also includes a connections interface 404, which corresponds to the data connection module 312. The data foundations interface 406 corresponds to the data foundation module 314. The business elements interface 408 corresponds to the business element module 316. The business views interface 410 corresponds to the business view module 318. The security interface 412 corresponds to the security module 320. A query engine interface 414 corresponds to a generic query engine, which may be stored in memory 310.

An administrator can access the graphical user interface 400 to construct a data foundation, which includes tables and columns from a variety of data connections that point to mixed corporate data sources (e.g., OLAP cubes, data mart, ERP, flat files, etc.). An organization can have multiple data foundations. Typically, a data foundation is made available across an enterprise. In accordance with an aspect of the invention, the data foundation module 314 facilitates data abstraction of enterprise data stored in diverse native formats.

In accordance with the invention, members of various business units or groupings create business elements, which are logical groupings of business data fields based on the data foundation. In particular, the executable instructions of the business element module 316 facilitate the logical grouping of enterprise data of the data store to form business elements. Business elements are typically specific to departmental needs. At the highest level of abstraction, end users employing a metadata consumer access business views, specifically relevant to certain business processes. The metadata consumer is a data access or reporting tool, such as Crystal Reports, sold by Business Objects Americas, Inc., San Jose, Calif. At each level, business users responsible for preparing mapped data need only model one abstraction, which can then be exposed to different audiences throughout the organization.

In one embodiment, the invention uses an object oriented framework based on an implementation designed to make it possible for users to build reusable components which can be distributed across the system. In addition to data connections, data foundations, business elements, and business views, other metadata specific objects such as filters, formulas, SQL expressions, parameters, and the like are also managed by the system's object repository.

The object repository model provides business users with a number of key technology benefits. First, it presents a framework for managed component reuse. Administrators, data managers, and other users throughout the metadata services hierarchy are able to rapidly develop data mapping summaries by making use of pre-existing data connections, filters, etc. that have been previously designed and housed in the object repository. For example, “Sales” data administrators located in disparate geographical regions can easily create composite, “Global Sales” based data foundations without having to personally design and implement a connection to each of the regional data stores. Instead, they can simply add the relevant data connections previously created by each of the regional managers in order to implement the required data abstraction.

The invention also provides an effective mechanism for object aggregation. Complex filters, calculations, security scenarios, etc. can be rapidly developed by aggregating existing filter, formula, and similar objects.

More involved aggregation scenarios entail the linking of parameter objects with security filters to implement more granular access restrictions for the system. It is significant to note that the object repository takes advantage of clustering, load balancing, and scalability technologies inherent to some existing enterprise applications, such as Crystal Enterprise, sold by Business Objects Americas, Inc., San Jose, Calif. The repository is not single file based and is capable of housing functions, text, images, and other objects (outside of metadata specific objects). The implementation makes it possible for a metadata services solution to achieve a level of scaling well beyond what is offered by existing solutions.

The metadata service technique of the invention makes it possible for administrators to cross heterogeneous data sources: OLAP, relational, flat file, and most other underlying data stores can be mapped collectively to provide users with a universal data access framework. It is important to note again that the technique of the invention does not produce data. In other words, the technique of the invention does not aggregate corporate data stores into a proprietary, unified repository. Rather, it serves as a lens to provide a view of the corporate information landscape. That is, it establishes only an abstract data structure that, in essence, is a structured summary of the source data.

A key differentiating feature of the methodology of the invention is that it does not impose any constraints on the shape of a resultant data map. Instead, the system automatically and dynamically determines the best shape of data based upon the query. More traditional business intelligence vendor solutions restrict data abstractions to either multi-dimensional or relational data sets, but not both, and the option to choose otherwise is generally not available given the underlying architecture of such systems.

The invention provides a vehicle for the effective abstraction of an organization's disparate data sources. In addition, the invention provides a robust data security module, which makes it possible to easily define row and column restrictions for aggregate data views. The invention also unifies relational and OLAP data models and therefore provides universal data access, regardless of the underlying data source.

The invention allows corporate users to bring together data from multiple data collection platforms across application boundaries so that the differences in data resolution, coverage, and structure between collection methods are eliminated. In addition, it is now possible for users to add any necessary business context to the aggregated data abstraction, including consistent definitions of corporate hierarchy or customer information.

As shown in FIG. 2, the metadata view module 100 sits on top of an information store 104, which may be an enterprise data access and reporting utility, such as Crystal Enterprise (CE) Software Development Kit (SDK), sold by Business Objects Americas, Inc., San Jose, Calif. The metadata view module 100 generates a structured summary of an organization's underlying source data. It can also be used to define row and column restrictions for data security.

The metadata view module 100 defines a hierarchy of objects used by content designers to affect the retrieval of all required data from an organization's data stores. The following discussion illustrates the operation of the metadata view module 100.

Data connections, implemented with the data connection module 312, specify and define the underlying data sources. They are, for example, connection objects to both relational and OLAP sources. Each data connection object contains information that describes the physical data source, such as the server and data being accessed, the logon credentials (optional), and the type of server being accessed.

A dynamic data connection, also implemented with the data connection module 312, is a collection of pointers to various data connections. An administrator or user is able to select the data connection or data connections to use through a parameter. This means that a report can point to a different underlying data source based on user name, locale, or via a user defined parameter.

One scenario involves the migration of data from a development system to a test system, and finally, to a production system. In this scenario, a report is run against a development system, and then, when the data is migrated to a test system, the same report is run against the test system's data. The only change required is that the dynamic data connection's settings must be updated so that it points to the test system's data connection. Finally, when the test system's data is migrated to the production system, the same report can again be run against the production system. This is important to enterprise customers because reports and reporting systems are typically considered custom code and are migrated via version control systems, and it is important that reports not require a design change during the migration process, otherwise the QA validation process could be bypassed.

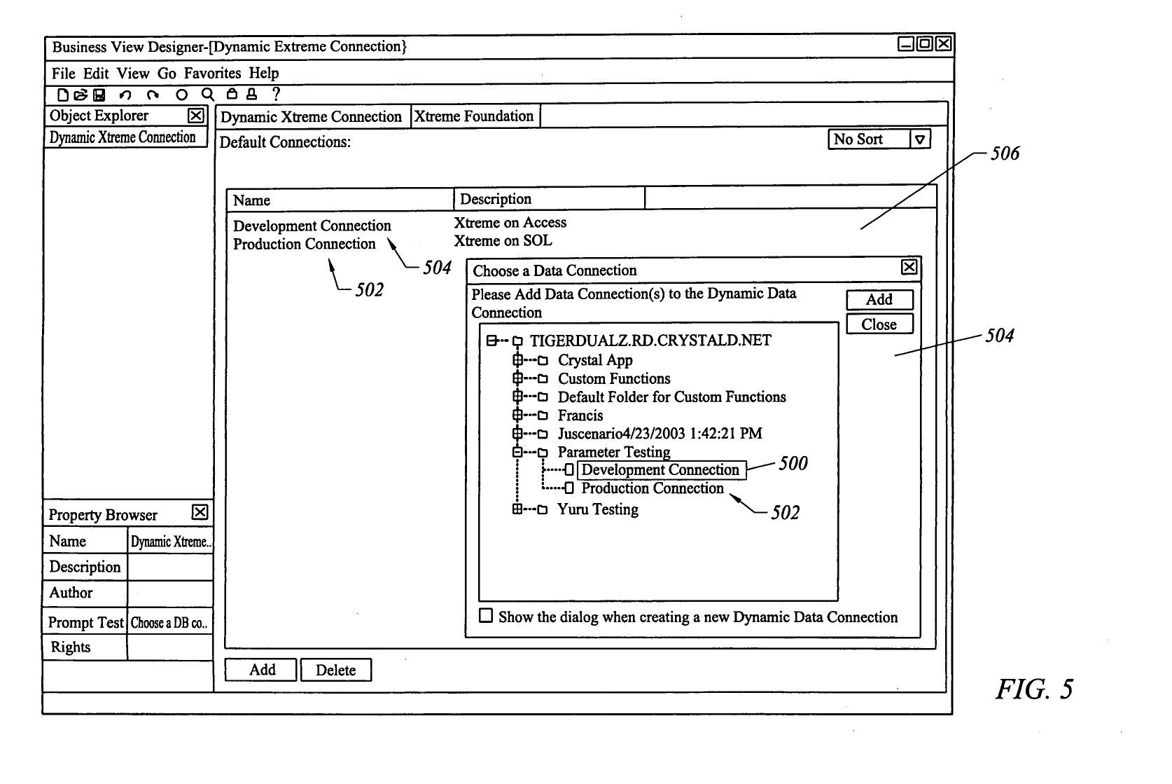

To create a dynamic data connection, it is first necessary to establish a set of static connections. (e.g., static connections to each of the development, test, and production data.) Once this is done, one creates a new “Dynamic Data Connection” via the ‘New Object’ menu, and adds the static connections to it. FIG. 5 illustrates the dialogue used for selecting existing static data connections to a new dynamic connection object. In this example, the development connection 500 exists in a Microsoft Access™ database and the Production Connection 502 is to an MS SQL Server™. These connections are chosen through dialog box 504 and are then displayed in window 506.

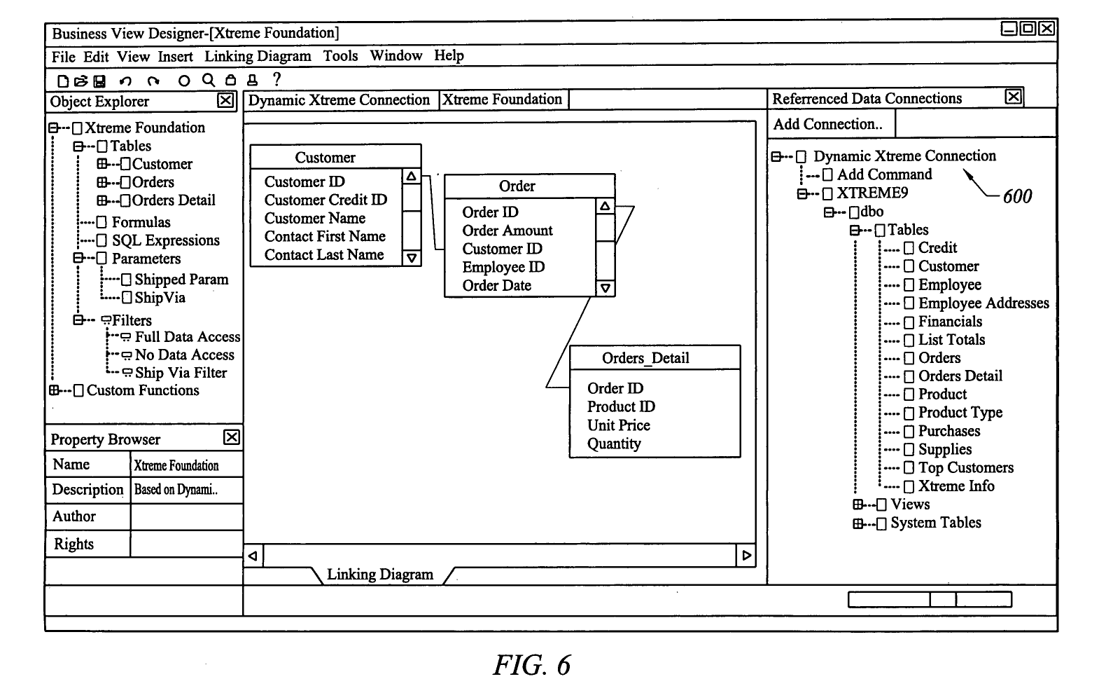

The next step is to add the dynamic data connection to a data foundation. FIG. 6 illustrates the design of a data foundation named ‘Xtreme Foundation’. In the ‘Referenced Data Connections’ dialogue on the right side of the interface, the connection it is based upon is the dynamic data connection named ‘Dynamic Xtreme Connection’ 600, which looks like a single database. Through the dynamic data connection one can access all of the data source constructs, such as tables, views, stored procedures, and SQL command objects.

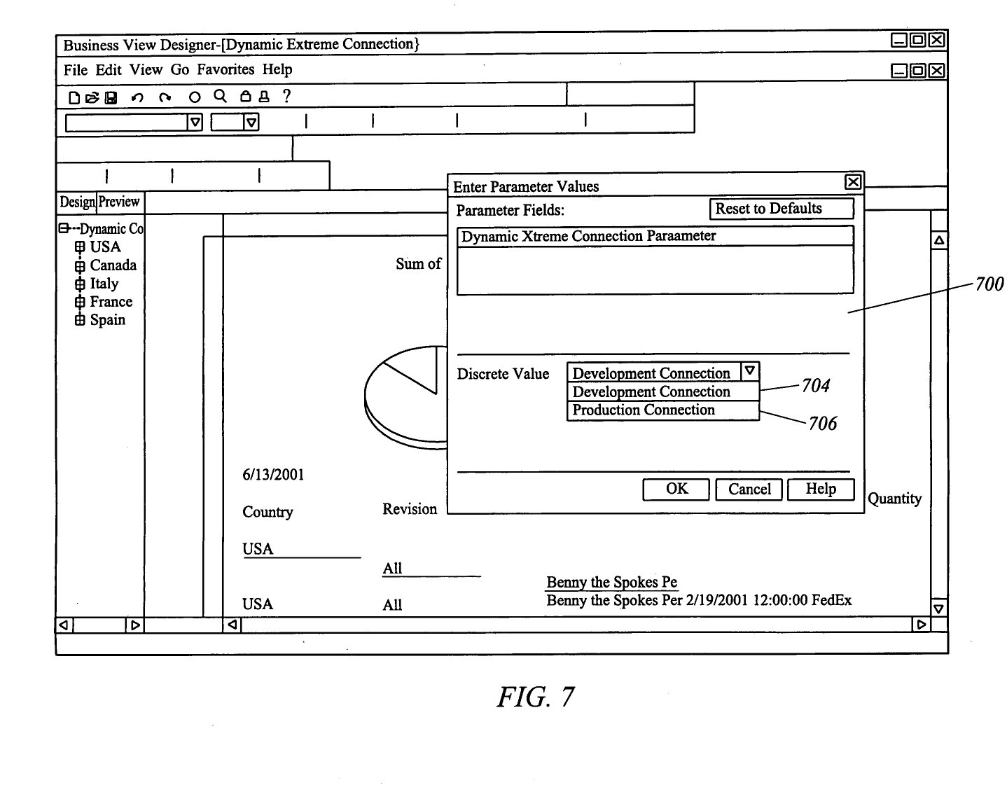

When users refresh reports that are based on a business view, which in turn is based on a dynamic data connection, they are prompted to specify which of the available data connections to use, as a parameter for the report. At the top of FIG. 7 one can see the parameter entry screen 700 for a report titled ‘Dynamic Connection.rpt’ based on the ‘Dynamic Xtreme Connection’ shown in FIG. 6. The parameter for the connection provides a Pick List of the available connections, in this case, a development connection 704 and a production connection 706.

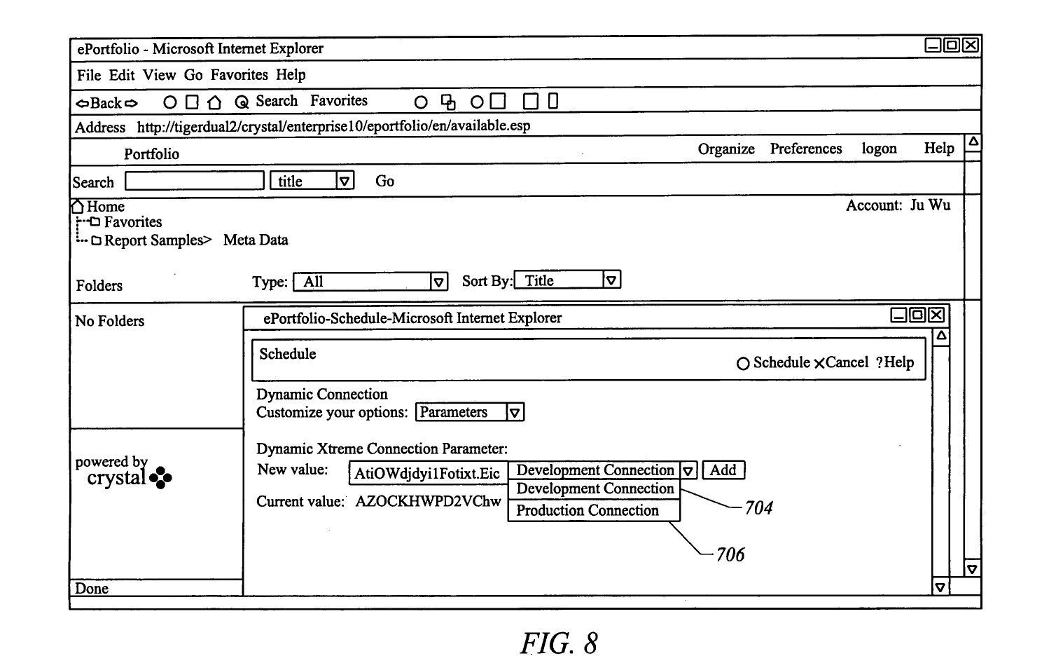

Likewise, users who schedule the same report are also prompted to specify the data connection to use. FIG. 8 illustrates the scheduling dialog for the ‘Dynamic Connection.rpt’ . Observe that the same parameter is exposed to the users at schedule or view time, along with the same Pick List in a dialogue, including development connection 704 and production connection 706.

In accordance with the invention, security for dynamic data connections can be implemented in a number of ways. For example, the “View” right may be used to hide connections (static and dynamic). Alternately, one may apply “Data Access” rights to limit data reading for the connection. (At design time, this limits data browsing. At run time, this limits the data that can be queried.)

The primary use of data foundations is for data abstraction: administrators control which tables and columns users can or cannot access when these users are designing or viewing a report. Typically, administrators create data foundations that are used across an enterprise, while business views are designed for specific groupings of information that are not enterprise-wide in deployment. A data foundation consists of collections of tables and columns. Note that in the context of metadata services, a “Table” can also be a cube fact table from an OLAP database, a stored procedure that includes private parameters, or a command table with shareable parameters. (All command tables and stored procedures should not change schema based on parameter values.) Default table links are defined at this level. Metadata services also supports strong link types to reinforce links. That is, tables that are linked with strong links are automatically imported when a user is building a business element or business view that uses the table. For example, in an ERP system, there may be thousands of tables. An administrator may define a data foundation called “HR” that includes 8 related tables with Human Resources data. When a user wants to build a report using one of the HR tables, the related tables are automatically made available for use.

Formulas (e.g., SQL expressions) can be applied at this level. Filters are generally applied as named selection formulas. It is also possible to create a composite filter from child filters and/or together. Security applied by the filter can be used as row-level security. Note that parameters can be used in a command table or filter.

A business element is a logically related collection of business data fields that are based on a data foundation. These fields are organized into a hierarchical structure within the business element, similar to OLAP dimensions. As an example, a hierarchical structure contains the following fields: Country, State or Province, and City. Note that business fields can be used to provide an alias name for a field, or may include a suggested summary operation for cube building. Relationships define the parent-child relationship between fields. (Relationships can also be used with OLAP hierarchy and relational grouping, or in cascading parameters.) It is possible to have multiple relationship chains that will fit the multiple hierarchies inside a single dimension. Filters defined within a business element must be used within the business element. Users can create a composite filter that references one or more filters in a data foundation and it will not inherit the security from the base. Users can also create a new filter that refers to fields in the element or the data foundation, including formula fields. Security for filters can be applied. (Some users may choose to use the security exclusively for the selection of rules.)

A business view is a logical collection of business elements. A business view provides the highest level of data abstraction for end users. Users see business views as virtual tables and fields; cubes also appear as business views. (That is, a cube from a database will become a business view, with all the same underlying objects-i.e. connections, data foundation, and business element). End users can access business views through applications such as Crystal Reports, Crystal Analysis, and the Report Application Server sold by Business Objects Americas, Inc., San Jose, Calif.

Observe that the data abstraction paradigm of the invention makes it possible for all data in an enterprise to be managed, joined, and viewed in a consistent manner, regardless of the origin. The invention's use of business views can be extended to derive another data abstraction layer, referred to herein as an analysis business view. An analysis business view characterizes business processes. Users can interact with an analysis business view as an object. Dimensionality is automatically handled for the user. This makes it possible for users to link OLAP cubes together based on common dimensions or new dimensions. Thus, the invention allows compound OLAP structures without having an administrator map the data based on the hierarchies inherent in the data. In previous solutions that enable the joining of cubes, administrators would have to explicitly map the elements of one dimension hierarchy to the other. In this case, the system can determine the mapping automatically. This enables users to be more independent once the initial abstraction layer is designed. The invention also allows users to join multidimensional structures to relational structures because it automatically applies hierarchy to relational data, effectively giving previously flat data “shape”.

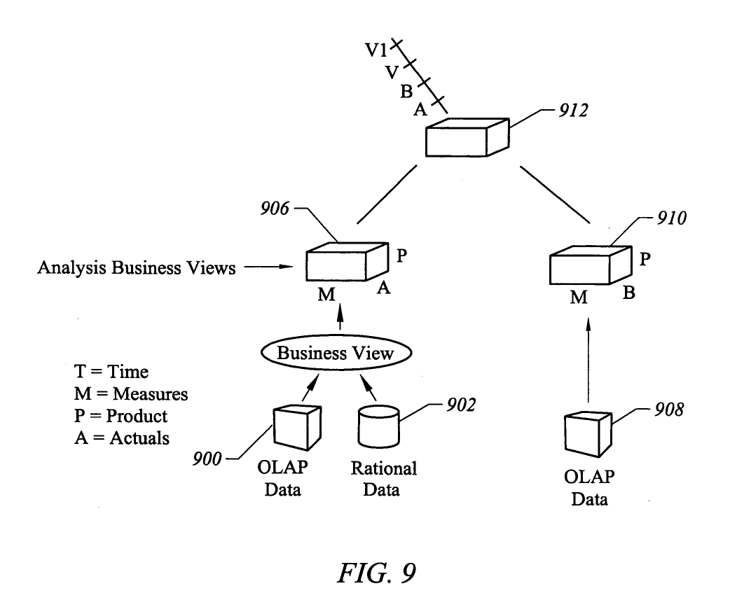

FIG. 9 illustrates abstractions operations that may be performed in accordance with an embodiment of the invention. FIG. 9 displays enterprise data in the form of OLAP data 900 and relational data 902, which is used to form a business view 904. The business view 904 may be further abstracted into an analysis business view 906. In parallel, a separate OLAP data source 908 may be used to form a different analysis business view 910. The two analysis business views 906 and 910 may then be combined into a unified analysis business view 912. This abstraction operation is achieved by utilizing common dimensions. In particular, as shown in the figure, exemplary dimensions of measures, actuals, products and time are used. Consider that a time dimension for sources 900 and 902 is used to cover the date ranges from January to December 2000. The time dimension for the OLAP source 908 is for the same months, but for 2001. The invention allows the two OLAP sources to be combined along common dimensions. For example, the budget and actuals data can be combined along a dimension that may include versioning information. The time dimension can be concatenated for the two OLAP sources. The unified analysis business view can then be scheduled and persisted as a cube populated with data that is then a managed object. For example, Crystal Enterprise, sold be Business Objects Americas, Inc., San Jose, Calif., may be used to manage this object.

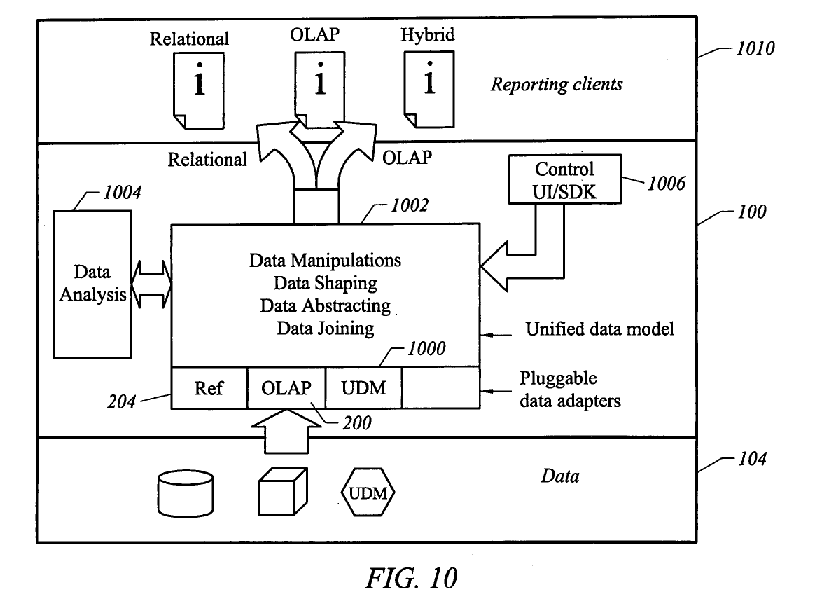

FIG. 10 illustrates another embodiment of the invention including many of the components illustrated in FIG. 2. In particular, the figure shows a data store 104 interacting with a metadata view module 100, which in this case includes an OLAP data service module 200 and a relational data service module 204. Executable code 1002 is also used to perform data manipulations, data shaping, data abstraction, and data joining. Module 1002 interacts with a data analysis module 1004. Controls through a user interface and software developer kit (SDK) are provided through executable module 1006. Reporting clients 1010 process the output of the metadata view module 100.

Observe that data from the information store 104 is accessed in a native way through the pluggable adapters 200, 204. This data is presented in a unified, abstract way. The abstraction of the data is important for the following reasons. There is no need in many cases to convert between one form of data and another. Conversions are often inefficient and slow, and should be avoided if possible. The act of adding shape to unshaped data will incur some overhead (e.g., building a cube), but that is not always necessary. The data can then be presented in a data source agnostic fashion. In other words, reporting clients can slice and dice regardless of source and produce listing reports regardless of source. These operations come through an OLAP and relational interface, respectively. The abstraction defines only what an implementation can do, not how it should be done. This avoids imposing a particular implementation on all data sources, for some of which it may not be relevant. Instead, each data source may have its own implementation suited to it, which exposes the base class abstraction. The abstraction tends to avoid a “lowest common denominator” problem, allowing even complex data sources (e.g., UDM) to be fully exposed. Any future data sources are less likely to be constrained by the abstraction. Thus, incorporating a new data source is hidden from the clients of the system. Contrast this with a new data source that requires all client code to be updated. In accordance with the invention, powerful manipulations and data shaping can be done with minimal code. If it was not abstracted, then to merge two relational, or one OLAP and one relational, or two OLAP data sources would require three sets of code. Instead, the architecture allows all operations to be handled in a general way, without preventing optimizations to be coded.

Observe that the reporting clients 1010 can choose to view the modeled data either in a relational way or an OLAP way. It is exactly the same underlying data regardless of interface choice. Data is not necessarily translated between formats. Thus, relational data may be passed right through the system without any OLAP being involved.

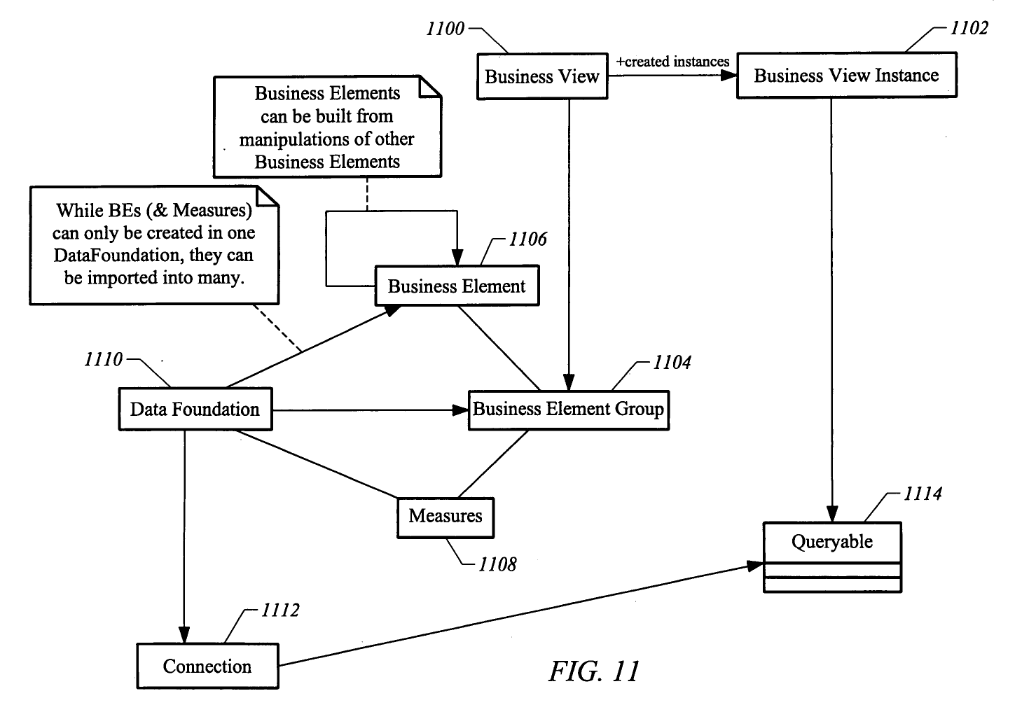

FIG. 11 illustrates a business view 1100. The business view may be used to create a business view instance 1102. The business view 1100 is formed from a business element group 1104, which may be formed by a business element 1106. Observe that a business element 1106 may be built from manipulations of other business elements. Measures 1108 may also be used to form a business element group 1104. The data foundation 1110 is the source of the business element 1106 and measures 1108. The data foundation is derived from a connection 1112. The business view instance 1102 may be subject to queries 1114.

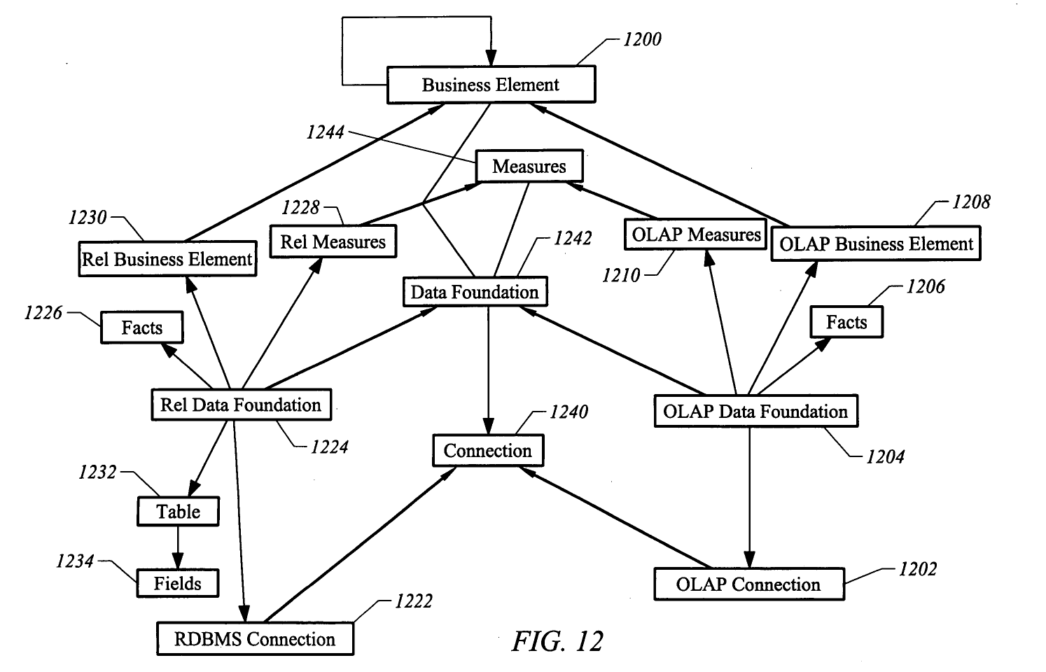

FIG. 12 illustrates the construction of a business element 1200 from two data sources. An OLAP connection 1202 is used to construct an OLAP data foundation 1204. The OLAP data foundation is used to produce facts 1206, an OLAP business element 1208, and OLAP measures 1210. In parallel, a relational database management system (RDBMS) connection 1222 is used to produce a relational data foundation 1224. The relational data foundation 1224 is then used to produce facts 1226, relational measures 1228 and relational business elements 1230. The relational data foundation 1224 also serves as a source for tables 1232 and fields 1234. These separate data sources are unified, in accordance with the invention, through a connection 1240, which is used to produce a data foundation 1242. The data foundation 1242 is a unified data foundation, based upon abstraction, which can then be used to produce common measures 1244 and a common business element 1200.

For a relational data source, the table joins are defined within a data foundation. This gives the logical grouping of data in the data foundation into one or more groups of business elements. For an OLAP data source, the administrator of the OLAP source has already done the logical grouping, and a cube is presented as a group of business elements within a data foundation. Business elements may then be mapped and combined to enhance groups or to form new groups of business elements.

In order for the abstractions to work, they must occur before any manipulations (e.g., joining, mapping, compounding) are performed. Therefore, the data is abstracted as low down in the model as possible. The business elements are the highest point of abstraction. Once a business element has been defined in terms of a specific data source, it may be manipulated like any other. Data foundations are of one type only. A group of business elements is defined in part by how they are related to each other, and to any fact data that may be available. So a group of business elements also has a base type and data source specific types.

If this abstraction was not in place, then the reporting system would rely on OLAP controls to display OLAP data, and relational controls to display relational data. In this case, there would be two stacks, which would go from the data source to the user interface. It would be possible to move data between the stacks by converting, but not to represent one in terms of the other. This would limit the usefulness of the data since in would not be possible to shape data from one source using another (e.g., use an OLAP hierarchy to shape relational data). Also it would not be possible to define security based on hierarchical operations without needing to know where the data came from. In addition, it would not be possible to compound data of different types together without converting one type first. The reuse of code to perform manipulations, joining and compounding would not be possible either.

Note that the abstraction is on the definition, not on the actual data. Thus, the base functionality that all business elements must conform to is expressed in terms of operations that can be done to definitions. To use a simple example, the renaming of a member is an operation that may be applied to all definitions of business elements regardless of source. The abstraction does not represent the superset of all the facets of a data source type. There may exist properties of a data source that do not get exposed in the base level business element definition. However, the appropriate repository will realize this definition at build time. The repository is aware of all the properties of the data source.

Mapping properties within business elements allows mapping one data source onto another in order to shape data. This allows the mapping to be performed without consideration of the data source type, since all business element properties are treated the same way, regardless of data source. This is an especially powerful feature, since it allows users to apply shape to their data without having to understand anything about the original data source. As an example, consider applying an organization hierarchy to some local relational data. The user needs only to tell the system that the ‘name’ property on the flat data is the same as the ‘full name’ property on the previously created business element. The system will then categorize the flat data accordingly. The user can even restrict the organizational hierarchy to only include those people that report directly to them. All this can be achieved without having to perform any table joins, understand any database schemas or create any calculated columns.

This power can be further utilized when joining entire meaningful groups of business elements together. This allows exposure of much of the power of compound OLAP. Compounding of business elements extends to joining any combination of data sources. For example, consider some store transactional data and an OLAP warehouse containing historical data. A store manager could use the compounding manipulations to create a new data source for reporting based on the historical data and the transactional data together. The compounding is specified in terms of business elements so the business manager does not need to know any SQL or any details about the underlying data stores or schemas.

The invention presents the business view and business element instances through either a relational or OLAP interface. The relational interface is always available, but the OLAP interface is only available on data that has definitions of hierarchies and aggregated data—built cubes, aliases on OLAP, and the like. Note that it is always exactly the same data that is presented. This is in contrast to building cubes from relational definitions, where it would be possible for the relational view to be out of sync with the OLAP view. It is up to the client tool to use a suitable interface for reporting type.

The invention does not impose an abstract data pipe between the data source and the reporting client, but instead abstracts (and joins) relational and OLAP concepts. The alternative, which is to always use a specific data type somewhere in the stack, imposes a conversion overhead. The invention only converts data when it has to, and at the lest expensive part of the stack. For example, a relational query onto a relational data source will be passed straight through, as will OLAP queries on an alias cube against an OLAP data source.

The architecture of the invention allows, but does not require, instances of business elements and business views to be built. The designer of a business view may elect to schedule a data instance to be built, which will take a snapshot of the data. This can be useful for speed considerations, especially in the case of cube building, and for taking historical snapshots of data. Performance can also be enhanced for relational business views, for example if the queries used to build the view are very complex. In this case, an instance could be saved to an appropriate data store. The choice to build a data instance is also based on the interface required. It may not be necessary to expose an OLAP interface from a business view. Thus, the designer can elect to not schedule a cube to be built if a relational interface is available without a long schedule job.

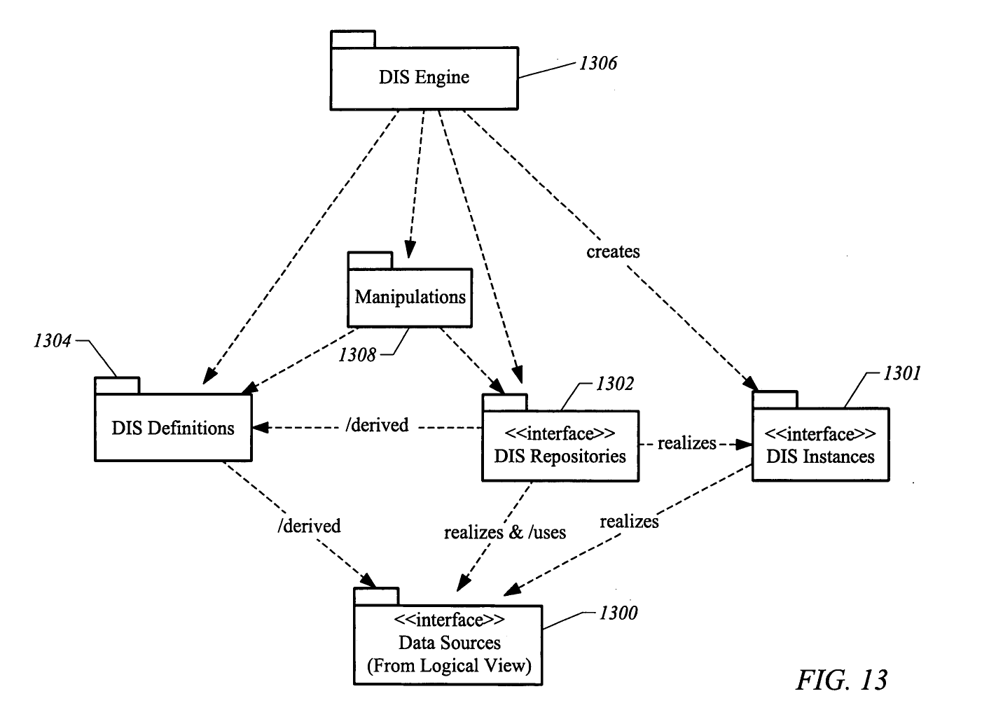

The data agnostic nature of the system allows new types of data sources to be added at a later stage without changing the overall architecture. Relational, OLAP, and explicitly entered data has already been considered. The invention is also applicable to future data sources, such as, Microsoft UDMs and aggregation aware relational sources. FIG. 13 illustrates an architecture to support new types of data sources. The figure illustrates a data source 1300. The figure also illustrates data integration services (DIS) instances. These instances are views on data that can be queried. For example, these may be business view and business element instances, not their definitions. One way to distinguish between a business view and business element instance is to refer to it as either solid or virtual. Solid refers to an object that actually contains data. Virtual refers to an object that contains no data, but references something that does and specifies how to use that data. An example of this is a compound cube.

FIG. 13 also illustrates repositories 1302. Repositories extend the functionality of data sources by adding interfaces for streaming data and accepting pushdown of operations and manipulations. Repositories are often implemented using an existing data source. Some repositories will build solid instances of business elements and business views.

FIG. 13 also illustrates DIS definitions 1304. These definitions support that data source agnostic definition of structure on data (i.e., business views) regardless of source and security applied to the structure. The definitions include classes that are used to define business elements, business views, connections, data foundations, and groups of business elements.

FIG. 13 also illustrates a DIS engine 1306. This engine creates views or instances that can be queried according to the definition, by manipulating and transforming the data in the underlying sources. The engine 1306 is responsible for providing business views for clients to query. The engine 1306 distributes the actions required to build any given business view or business element across processes and pushes as many actions as it can onto the repositories in order to maximize the processing close to the data sources.

The manipulators 1308 are a collection of executable functions for manipulating the shape and content of data, whether that data is retrieved by query or stream. The manipulators also contain mechanisms for defining a graph of those functions and facilities to manipulate the graph. The manipulators can also be used to implement security.

The business views and their components are defined using the classes in the definitions package 1304. The engine 1306 determines what needs to be built at any given moment, according to preferences set on the definitions and performance heuristics. The engine 1306 may hand off straight to a repository providing a solid instance. The engine 1306 may build up a chain of manipulators to create a virtual instance from a data source or implement security over an external data source or a combination of the two. Support for defining and building business views and their content from any arbitrary data source is achieved by plugging in specializations of definitions and repositories for that particular type of data source.

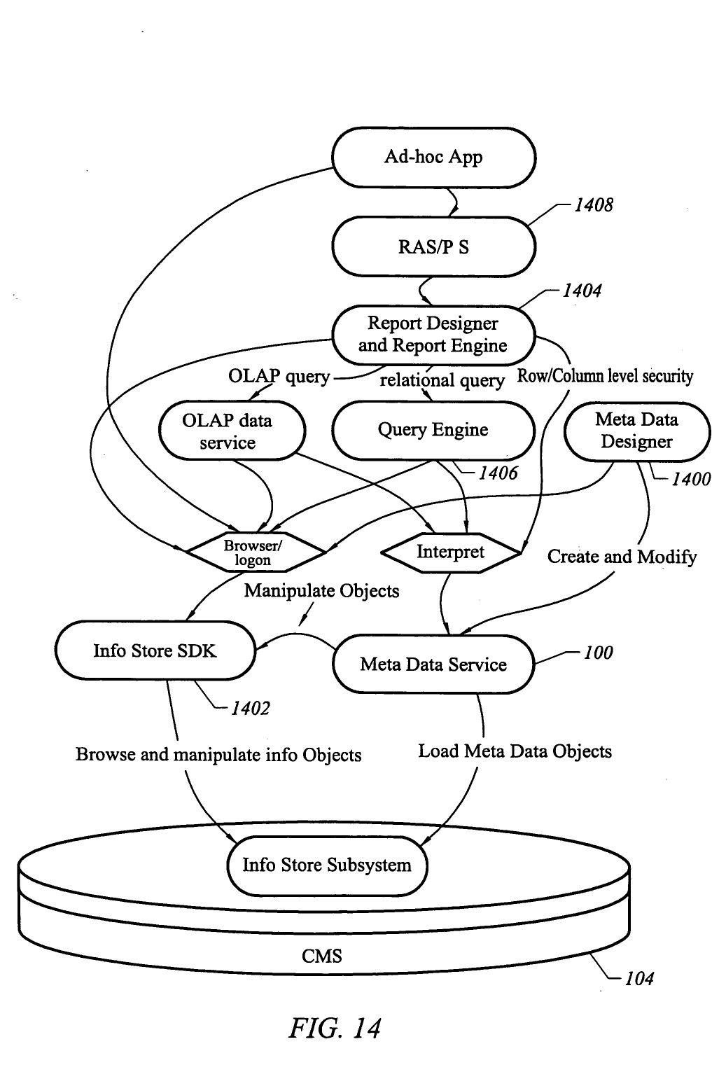

As shown in FIG. 14, the metadata module 100 of the invention integrates with a number of enterprise components. That is, the metadata module 100 may be utilized with various ancillary enterprise software modules, such as shown in Figure. 14. The metadata designer 1400 is a thick client application. The metadata designer is the only metadata specific component that administrators interact with directly. The designer makes it possible for administrators to create and modify metadata service objects: the administrator uses this designer to specify different data connections, set data security and control access to the underlying corporate data stores.

FIG. 14 also illustrates an information store 104. In this embodiment, the information store 104 is a Crystal Enterprise information store supplied by Business Objects Americas, Inc., San Jose, Calif. The information store 104, referred to as a Crystal Management Server (CMS), is employed as the object repository for all objects exposed by the metadata module 100. In this embodiment, the CMS treats any information object as a generic entity, referred to as an “InfoObject”. The CMS InfoStore is the subsystem used to store each InfoObject, as well as most of the information needed by the Crystal Enterprise system to run.

The metadata module 100 of the invention may also be integrated with a Crystal Enterprise Software Development Kit (CE SDK) sold by Business Objects Americas, Inc., San Jose, Calif. The CE SDK, shown as block 1402 in FIG. 14, serves as the object browsing API for metadata objects (connections, data foundations, business elements, business views, etc.). A Crystal Reports Designer may also be used with the metadata service of the invention. The CRD is a client application used to create reports based on metadata.

The query engine 1406 works with the metadata SDK to process virtual queries on top of data abstractions. In the current implementation, the report engine (CRPE) imposes row and column restrictions; the Query Engine takes the calculated results to process queries. The Crystal Report Print Engine is responsible for securing the “live” and saved data based on row and column level security restrictions.

The Report Application Server 1408 is used when creating or modifying a report based on metadata. Users first use the CE SDK to browse business views and a corresponding InfoObject is passed to the RAS SDK for report creation. The Crystal Management Console (CMC) is used if logon credentials to the underlying data source(s) are not saved as part of the data connection. Caching changes may be required given a scenario in which users need to be distinguished based on view time row restrictions.

The Crystal Analysis server and Crystal Analysis clients are required when users use metadata to build cubes or consume cube data. The Ad-hoc application will be able to leverage metadata for on-demand cube building. It could also use metadata filters as rules for record selection (e.g. users could define filters for ‘Big Customer’ or ‘Top Sales’ in the metadata, and then apply them for ad-hoc reporting).

The metadata services of the invention makes it possible to assign view, design, data access, and set security rights on metadata objects and folders. (Not all objects have all rights available.) View, design, and set security are generally applied at design time. The data access right is used to control read access to the underlying data source. Note that rights can be granted and denied for all objects except filters.

The following table details metadata objects and the security settings that can be applied to each in accordance with an embodiment of the invention:

| MetaData | | | Data | Set |
|---|---|---|---|---|
| Object | View | Design | Access | Security |
| Folder¹ | Yes | Yes | No | Yes |
| Connection | Yes | Yes | Yes | Yes |
| Object² | | | | |
| Data | View | Yes | No | Yes |
| Foundation³ | | | | |
| Field Objects⁴ | No | No | Yes | No |
| Filters⁵ | No | No | Yes | No |
| Business | Yes | Yes | No | Yes |
| Elements | | | | |
| Business | Yes | Yes | No | No |
| Views | | | | |

¹Objects in a folder inherit the rights from the folder. (This is the default behavior.)
²The View, Design and Set Security rights are primarily for designers. The data access right is primarily used to stop users from accessing the physical data at run time.
³If the set security right is not granted, users will not be able to set security for objects in the data foundation.
⁴This applies to all fields types (data field, expression field, formula field, and business field). The data access right in this case is used to control data access for the field. It is applied at run time for querying and at design time for data browsing.
⁵Not granting the data access right does not imply that the right is denied. (It simply means that the right is not specified.) There is, in fact, no deny right for this object. (See following section on “filters” for more detail.)

By default, the metadata root folder grants view rights to “Everyone” and the metadata designer group is granted view, design, and set security rights.

Users will need to have the design right granted for a business view in order to perform “full” loading. Users who only have the view right granted will not see the entire data foundation: only the portion of the data foundation required to build the business view will be available. In general, administrators should deny their users (except metadata designers) view rights to any metadata level below the business view. This is prudent to ensure that users are not able to use the InfoStore API to retrieve properties.

Note that when metadata services performs minimal loading, the system checks the data access rights for all related objects in a single query. The system ascertains the security that needs to be applied for the logon user and determines whether the user has data access rights for the object. An example of this process is provided below. The invention provides column level security. The data access right for business fields controls column level security. If a user does not have the data access right, it will not be possible to see the field in metadata (or in the Report Designer). Null values are returned, as it will not be possible to read the data from the field. Preferably, no caching is performed in RAS or the Page Server if there is a column level restriction in place.

Filters are metadata objects that are used to restrict access to data. A filter could be used, for example, to restrict data access by region or employee type. Filters are used to implement data security. Filters applied to a business element are always included, i.e. security is always applied, regardless of whether the field is in a business element with a filter. Filters applied to a data foundation are only included if the base table for the filter is included in the business element. For example, a filter based on the table EMPLOYEES and the field OFFICE₁₃LOCATION would not be included if a user built a report that did not use the EMPLOYEES table. In the SQL context, the filters do not rely upon a select clause.

If multiple filters are applied at the same level, a logical OR operation is performed between them. If multiple filters are applied at different levels, a logical AND operation is performed between them.

Row level restrictions can be implemented using filters with security. All filters with security in their elements (that have fields in the query) are included when accessing data—this includes all related filters with security at the data foundation level. General rules can be used to determine if a data foundation related filter applies. For example, determine the data foundation tables that are referenced by the element fields used in a query. Any filter with security that is related to these tables is considered a “related data foundation filter”. If these tables have a direct enforced link, the system includes all the tables that are linked. All filters with security related to these tables will be appended to the related data foundation filters collection. All related data foundation filters across multiple tables are included in the final collection only if all related tables for the filters are in the final table list. There will never be a partial filter.

An embodiment of the invention includes two pre-defined filters: No Limit and No Access. These are included in both the data foundation and business element levels as long as security is applied. When users log in, the system checks their data access rights against the two filter collections. The filter collections that the users has rights to will be subject to a logical OR operation within the collection, and a logical AND operation across collections.

Composite filters are similar to dynamic data connections in that they are collections of pointers to filters. For example, a user can create a composite filter called “Bonus View Filter” that includes the filters “REGION=NA”, “BU=RD” and “EMP₁₃TYPE=Manager” and apply all three filters by applying just the one composite filter.

The data access right on a data connection can be used to limit access to corporate information stores. Users who do not have the data access right granted for a data connection will only be able to design, but not view. When users create a report based on a business view with security, they need to logon to the database in order to retrieve the data. The system needs to authenticate the database user logged on as the same user who is defined in the metadata—the DB DLL name, provider name, and server name will be verified.

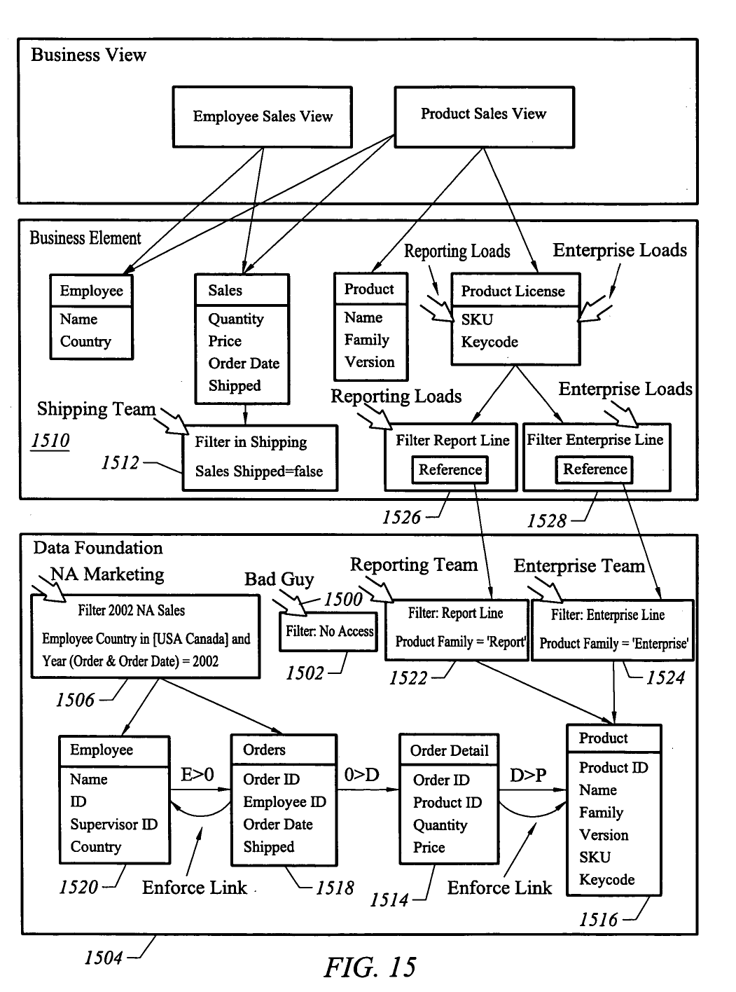

FIG. 15 illustrates a business view with instances of an employee sales view and a product sales view. The figure also illustrates a business element with “employee”, “sales” “product” and “product license” fields. The business element also includes “In Shipping”, “Report Line” and “Enterprise Line” filters. The arrows in the figure represent different users attempting to access different fields.

FIG. 15 also illustrates a data foundation. In this example, the data foundation has the following filters: “2002 NA Sales”, “No Access” , “Report Line”, and “Enterprise Line”. The data foundation also has the following fields: “Employee”, “Orders”, “Order Detail”, and “Product”. As discussed below, there is an enforced link between the orders field and the employee field. In addition, there is an enforced link between the order detail field and the product field.

In this example, report files which report off of the “Employee Sales” and “Product Sales” business views are created and various user access scenarios are presented. Steps 1a through 1c and 2a through 2c simply illustrate the expected behavior when users with different access levels view the same report. Explanations as to why a user sees or does not see certain data is provided.
1. Create Report on Employee Sales View
   a. Query Fields are: Name and Country.
      i. Actual fields in the query are: Employee.Name and Employee.Country.
      ii. Login as Bad Guy (Bad Guy is not part of NA Marketing team) The No Access filter will be applied, so the Bad Guy will see nothing. This is illustrated with arrow 1500 and filter 1502.
      iii. Login as member in NA Marketing Team On the data foundation level 1004 the filter “2002 NA Sales” 1006 will not be applied because the enforced link is not from Employee to Orders. Filter “No Access” 1502 will not be applied. Therefore, the data foundation filter will be empty. On the business element level 1510 the filter “In Shipping” 1512 will not be applied either. So there will be no row restriction for the NA Marketing Team.
      iv. Login as member in Shipping Team On the data foundation level 1504 none of the filters will be applied. On the business element level 1510 the filter “In Shipping” 1512 is not the Employee element, so the final filter will be empty.
      v. Login as other people Row restriction is empty.
   b. Query Fields are: Quantity, Price, Order Date, and Shipped
      i. Because of the enforced link from “Order Detail” 1514 to “Product” table 1516 and from “Orders” 1518 to “Employee” 1520, the “Product” and “Employee” table will be included in the query. Thus, all four tables of the data foundation level 1504 will be included in the query. All of the possible fields for any related filters are included even if the fields are not applied for the current user. This provides view time row restriction filter evaluation on the saved data. The actual query fields are: Employee.Country, Orders.Order Date, Orders.Shipped, Order Detail.Quantity, Order Detail.Price, and Product.Family.
      ii. Login as Bad Guy Same as a (ii).
      iii. Login as member NA Marketing Team On the data foundation level 1004 the filter “2002 NA Sales” 1506 will be applied because the enforced link will bring in table Employee 1520. Filter “No Access” 1502 will not be applied. If the user is from Reporting Team, the filter “Report Line” 1522 will be applied. In this case the data foundation filter will be “Employee.Country in [‘USA’, ‘Canada’] and Year({Orders.Order Date})=2002 or Product.Family=‘Report’”. That is, a logical OR operation is performed between the two filters. If the user is from the Enterprise team, the filter “Enterprise Line” 1524 will be applied. Then the final data foundation level filter will be “Employee.Country in [‘USA’, ‘Canada’] and Year({Orders.Order Date})=2002 or Product.Family=‘CE’”. On the business element level the filter “In Shipping” 1512 will not be applied. So the final row restriction will be the same as the data foundation level row restriction.
      iv. Login as member of Shipping Team On the data foundation level the filter “2002 NA Sales” 1506 will not be applied. On the business element level the filter “In Shipping” 1512 will be applied. So the final row restriction is the filter “In Shipping”.
      v. Login as other people Same as a (v)
   c. Query Fields are: Order Date, and Shipped
      i. The enforced link from “Orders” 1518 to “Employee” 1520 will bring in “Employee” table. The actual query fields will be Employee.Country, Orders.Order Date and Orders.Shipped.
      ii. Login as Bad Guy Same as a (ii).
      iii. Login as member in NA Marketing team. On the data foundation level the filter “2002 NA Sales” 1506 will be applied because the enforced link will bring in table Employee. On the business element level the filter “In Shipping” 1512 will not be applied. So the final filter will be “Employee.Country in [‘USA’, ‘Canada’] and Year({Orders.Order Date})=2002”.
      iv. Login as member in Shipping Team Same as b (iv)
      v. Login as other people Same as a (v)
2. Create Report on Product Sales View
   a. Query Fields are: Name and Country. Same as 1 (a).
   b. Query Fields are: Order Date, and Shipped Same as 1 (c).
   c. Query Fields are: Quantity, Price, Order Date, and Shipped Same as 1 (b).
   d. Query Fields are: Quantity, Price, Order Date, Shipped, Product.Name and Product.Family. Same as 1 (b) except query fields will have include one more field Product.Name.
   e. Query Fields are: Quantity, Price, Order Date, Shipped, Product.Name, Product.Family, SKU and Keycode (only for “Reporting Lead” and “Enterprise Lead”).
      i. The actual query fields are: Employee.Country, Orders.Order Date, Orders.Shipped, Order Detail.Quantity, Order Detail.Price, Product.Family, Product.SKU and Product.Keycode (only for “Reporting Lead” and “Enterprise Lead”).
      ii. Only “Reporting Lead” and “Enterprise Lead” are granted access to the Keycode field, so nobody else could see the field other than these two groups. All the row restriction filters on the BE level are combined through a logical “OR” operation. A column restriction is used to protect the sensitive data “Keycode”. To implement a logical “AND” operation, one needs to move them to either the data foundation level or control what elements get put into the business view.
      iii. Login as Bad Guy Same as a (ii).
      iv. Login as member in NA Marketing team not in the two leads group. Same as 1-b-iii. No Keycode field data.
      v. Login as member in Shipping Team. Same as 1-b-iv. No Keycode field data.
      vi. Login as member in Reporting Lead (also member of NA Marketing). On the data foundation level filter “Report Line” 1522 and “2002 NA Sales” 1506 will be applied, so the final DF filter will be “Product.Family=‘Report’ or Employee.Country in [‘USA’, ‘Canada’] and Year({Orders.Order Date})=2002”. On the business element level filter “Report Line” 1526 will be applied. So the final filter will be “(Product.Family=‘Report’ or Employee.Country in [‘USA’, ‘Canada’] and Year({Orders.Order Date})=2002) and Product.Family=‘Report’”. Can see Keycode field for “Report” product line only.
      vii. Login as member in Enterprise Lead (also member of NA Marketing). It is very similar to the previous case. The final filter is: “(Product.Family=‘Enterprise’ or Employee.Country in [‘USA’, ‘Canada’] and Year({Orders.Order Date})=2002) and Product.Family=‘Enterprise’”. Can see Keycode field for “Enterprise” product line only.
      viii. Login as member from both Lead groups (also member of NA Marketing). It is the combination of the previous two cases. The final filter is: “(Product.Family=‘Report’ or Product.Family=‘Enterprise’ or Employee.Country in [‘USA’, ‘Canada’] and Year({Orders.Order Date})=2002) and (Product.Family=‘Report’ or Product.Family=‘Enterprise’)”. Can see Keycode field for both “Report” and “Enterprise” product lines.
      ix. Login as others Same as 1-a-v. No Keycode field data.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium storing executable instructions, comprising:
a metadata view module including,
a data foundation module to facilitate data abstraction of enterprise data,
wherein said enterprise data is stored in diverse native formats;
a business element module to facilitate the logical grouping of said enterprise data to form business elements; and
a business view module to facilitate the logical grouping of business elements.

2. The computer readable medium of claim 1 wherein said metadata view module facilitates data abstraction of enterprise data stored in a relational data source and an On Line Analytic Processing (OLAP) data source.

3. The computer readable medium of claim 1 wherein said metadata view module facilitates data abstraction of enterprise data stored as a data source selected from the group comprising: legacy data, transactional data, enterprise application data, warehouse data, and custom data.

4. The computer readable medium of claim 1 further comprising a data connection module to facilitate connection to a pre-existing data link and thereby form a view of a pre-existing data channel.

5. The computer readable medium of claim 4 wherein said data connection module facilitates connection to a development system, a test system, and a production system.

6. The computer readable medium of claim 1 further comprising a security module to control access to said enterprise data.

7. The computer readable medium of claim 6 wherein said security module includes filters defined at a data foundation level.

8. The computer readable medium of claim 6 wherein said security module includes filters defined at a business element level.

9. The computer readable medium of claim 1 wherein said metadata view module supplies data views in accordance with a dynamic determination of the best data view shape for a specified query.

10. A method of accessing data, comprising:
accessing enterprise data stored in diverse native formats, wherein accessing includes
logically grouping sub-sets of said enterprise data to form business elements, and
logically combining sub-sets of business elements into a business view.

11. The method of claim 10 further comprising accessing enterprise data stored in a relational data source and an On Line Analytic Processing (OLAP) data source.

12. The method of claim 10 further comprising accessing enterprise data stored in a data source selected from the group comprising: legacy data, transactional data, enterprise application data, warehouse data, and custom data.

13. The method of claim 10 further comprising accessing a pre-existing data link to form a view of a pre-existing data channel.

14. The method of claim 10 further comprising sequentially accessing a development system, a test system, and a production system.

15. The method of claim 10 further comprising controlling access to selected data of said enterprise data using object-oriented filters.

16. The method of claim 15 further comprising controlling access to selected data of said enterprise data using object-oriented filters operative at a data foundation level.

17. The method of claim 15 further comprising controlling access to selected data of said enterprise data using object-oriented filters operative at a business element level.

18. The method of claim 10 further comprising supplying data views in accordance with a dynamic determination of the best data view shape for a specified query.
